(19) United States
(12) Patent Application Publication
(10) Pub. No.: US 2007/0128459 A1
(43) Pub. Date: Jun. 7, 2007

(54) Poly(trimethylene terephthalate)/poly(alpha-hydroxy acid) films

(76) Inventors: Joseph V. Kurian, Hockessin, DE (US); Richard E. Godwin, Wilmington, DE (US); Gyorgyi Fenyvesi, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/605,699

(22) Filed: Nov. 29, 2006

Related U.S. Application Data
(63) Continuation-in-part of application No. 11/296,176, filed on Dec. 7, 2005, now abandoned.
(63) Continuation-in-part of application No. 11/296,157, filed on Dec. 7, 2005, now abandoned.
(60) Provisional application No. 60/751,816, filed on Dec. 20, 2005.

(51) Int. Cl. B32B 27/36; C08L 67/00; C08G 63/00

(52) U.S. Cl. 428/480; 525/437

(57) ABSTRACT

This invention relates to poly(trimethylene terephthalate)/poly(alpha-hydroxy acid) films, methods for making the same and end uses thereof.

### CROSS-REFERENCE TO RELATED APPLICATIONS

This is a continuation-in-part of application Ser. Nos. 11/296,176 and 11/296,157 (both filed Dec. 7, 2005), and further claims priority under 35 U.S.C. §119 from Provisional Application No. 60/751,816 (filed Dec. 20, 2005), the disclosures of which are incorporated by reference herein for all purposes as if fully set forth.

### FIELD OF THE INVENTION

This invention relates to poly(trimethylene terephthalate)/poly(alpha-hydroxy acid) films, methods for making the same and end uses thereof.

### BACKGROUND OF THE INVENTION

Poly(trimethylene terephthalate) (“PTT”) and its use in many applications, including molded, shaped products, has been described in the literature. PTT is a polyester derived from terephthalic acid or an ester thereof and trimethylene glycol (also known as 1,3-propanediol) (“PDO”). The PDO may be prepared by various chemical or biochemical routes, including from various sugar sources such as corn, thus can be prepared from a renewable resource: New PTT articles having improved toughness, elongation and surface properties have been desired. In addition, since terephthalic acid and its esters are presently prepared from petroleum base, it is desired to increase the green (renewable resource base) of PTT compositions without harming the overall properties of products.

Japanese Patent Publication No. 2003-041435 describes mixtures of PTT and 1-10 wt % of a polyester consisting essentially of polylactic acid. The mixtures are used to prepare hollow, crimped staple fibers. Poly(lactic acid) can also be prepared from a renewable resource, being prepared from lactic acid (2-hydroxypropionic acid) and its intermolecular esters that are in turn prepared from carbohydrates by lactic acid fermentation. Japanese Patent Publication No. 2003-041435 is focused on using polylactic acid to provide a more stable crimp, and does not describe films or improvements thereto.

### SUMMARY OF THE INVENTION

The invention is directed to a film comprising a polymer composition comprising about 20 to about 98 wt %, by weight of the polymer composition, of poly(trimethylene terephthalate) and about 80 to about 2 wt %, by weight of the polymer composition, of poly(alpha-hydroxy acid).

Preferably the polymer composition comprises at least about 30 wt %, more preferably at least 40 wt %, even more preferably at least 50 wt %, even more preferably greater than 50 wt %, even more preferably at least 60 wt %, and most preferably at least 75 wt %, by weight of the polymer composition, of poly(trimethylene terephthalate). Preferably the polymer composition comprises up to about 95 wt % of poly(trimethylene terephthalate).

Preferably the polymer composition comprises up to about 70 wt %, more preferably up to about 60 wt %, more preferably up to about 50 wt %, more preferably less than about 50 wt %, more preferably up to about 40 wt %, and most preferably up to about 25 wt %, by weight of the polymer composition, of the poly(alpha-hydroxy acid). Preferably the composition comprises at least about 5 wt %, by weight of the polymer composition, of the poly(alpha-hydroxy acid).

Preferably, the poly(trimethylene terephthalate) is made with a 1,3-propane diol prepared by a fermentation process using a renewable biological source.

Preferably the poly(alpha-hydroxy acid) is polylactic acid, more preferably a bio-derived polylactic acid.

Preferably the film is about 0.1 mil to about 100 mils thick. In one preferred embodiment, the film is about 0.1 mil to about 15 mils thick. In another preferred embodiment, the film is about 15 mil to about 100 mils thick.

In one preferred embodiment, the film is a biaxially oriented film. In another preferred embodiment, the film is a cast film.

In one preferred embodiment, the film is a monolayer film. In another preferred embodiment, the invention is directed to a multilayer film, comprising at least one film layer comprising a polymer composition comprising about 20 to about 98 wt %, by weight of the polymer composition, of poly(trimethylene terephthalate) and about 80 to about 2 wt %, by weight of the polymer composition, of poly(alpha-hydroxy acid). In a preferred embodiment, the multilayer film is prepared by laminating at least one film layer to at least one other film layer or substrate. In another preferred embodiment, a multilayer film is prepared by coextrusion of the at least one film layer with at least one other film layer selected from the group consisting of polyolefin, ethylene copolymer, ionomer, polyamide, polycarbonate, acrylic, polystyrene, ethylene vinyl alcohol, polyvinylidene chloride, and other synthetic polymer film layers; and wherein the multilayer film optionally comprises one or more adhesive tie layers.

In a preferred embodiment, the film is a blown film.

The invention is also directed to articles made from the film. Such articles can be prepared from monolayer or multilayer films. Examples of articles are containers (e.g., bottles and cosmetic containers), and other multilayered laminated structures. Included are thermoformed and vacuum thermoformed articles.

The invention is also directed to preparing the films, including the monolayer films and multilayer films, and articles. For instance, in one embodiment it is directed to a process for preparing a film, comprising the steps of: (a) providing a polymer composition comprising about 20 to about 98 wt %, by weight of the polymer composition, of poly(trimethylene terephthalate) and about 80 to about 2 wt %, by weight of the polymer composition, of poly(alpha-hydroxy acid), and (b) forming a film.

The films, film layers and articles of the invention had similar or better properties to those prepared with PTT alone. Most notably, modulus and surface appearance have improved. This is unexpected since poly(alpha-hydroxy acid) polymers have significantly lower physical and mechanical properties than PTT. Thus, using poly(alpha-hydroxy acid) polymers, the artisan can increase the green content (renewable resource percentage) in a film, film layer or article without significantly deteriorating the properties of the final product.

### DETAILED DESCRIPTION OF THE PREFERRED EMBODIMENTS

All publications, patent applications, patents, and other references mentioned herein are incorporated by reference in their entirety. Unless otherwise defined, all technical and scientific terms used herein have the same meaning as commonly understood by one of ordinary skill in the art to which this invention belongs. In case of conflict, the present specification, including definitions, will control.

Except where expressly noted, trademarks are shown in upper case.

The materials, methods, and examples herein are illustrative only and, except as specifically stated, are not intended to be limiting. Although methods and materials similar or equivalent to those described herein can be used in the practice or testing of the present invention, suitable methods and materials are described herein.

Unless stated otherwise, all percentages, parts, ratios, etc., are by weight.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

When the term “about” is used in describing a value or an end-point of a range, the disclosure should be understood to include the specific value or end-point referred to.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Use of “a” or “an” are employed to describe elements and components of the invention. This is done merely for convenience and to give a general sense of the invention. This description should be read to include one or at least one and the singular also includes the plural unless it is obvious that it is meant otherwise.

This invention relates to polymer compositions, melt-blended mixtures, films, film layers and articles (or article layers) comprising the polymer compositions. The polymer compositions and melt-blended mixtures, comprise poly(trimethylene terephthalate)s and polymers of alpha-hydroxy acids. The amount of the polymer of alpha-hydroxy acid or acids is at least about 2%, more preferably at least about 5%, and in some cases more preferably at least about 10%. The amount of the polymer of an alpha-hydroxy acid is up to about 80%, preferably up to about 75%, in another embodiment up to about 60%, in yet another embodiment up to 50%, in a further embodiment less than 50%, in yet a further embodiment up to about 40%, and in an addition embodiment up to about 25%. Preferably the poly(trimethylene terephthalate) is used in an amount of up to about 98%, in another embodiment preferably up to about 95%, and in an additional embodiment preferably up to about 90%. It is preferably used in amount of at least about 20%, in another embodiment at least about 25%, in another embodiment at least about 40%, in yet another embodiment preferably at least about 50%, in a further embodiment greater than 50%, in an additional embodiment at least about 60%, and in one additional embodiment at least about 75%. The foregoing are weight percentages, and are based upon the total weight of the polymer compositions and melt-blended polyester mixtures, respectively. For convenience, polymer compositions of the invention are sometimes referred to as “PTT/PAHA polymers”.

Poly(trimethylene terephthalate) or PTT, is meant to encompass homopolymers and copolymers containing at least 70 mole % trimethylene terephthalate repeat units. The preferred poly(trimethylene terephthalate)s contain at least 85 mole %, more preferably at least 90 mole %, even more preferably at least 95 or at least 98 mole %, and most preferably about 100 mole %, trimethylene terephthalate repeat units.

Poly(trimethylene terephthalate) is generally produced by the acid-catalyzed polycondensation of 1,3-propane diol and terephthalic acid/diester, with optional minor amounts of other monomers.

When the PTT is a copolymer, it can contain up to 30 mole %, preferably up to 15 mole %, more preferably up 10 mole %, even more preferably up to 5 mole %, and most preferably up to 2 mole %, and of repeating units that contain other units. These repeating unit preferably contain dicarboxylic acids having 4-12 carbon atoms (for example butanedioic acid, pentanedioic acid, hexanedioic acid, dodecanedioic acid, and 1,4-cyclo-hexanedicarboxylic acid); aromatic dicarboxylic acids other than terephthalic acid and having 8-12 carbon atoms (for example isophthalic acid and 2,6-naphthalenedicarboxylic acid); and linear, cyclic, and branched aliphatic diols having 2-8 carbon atoms other than 1,3-propanediol (for example, ethanediol, 1,2-propanediol, 1,4-butanediol, 3-methyl-1,5-pentanediol, 2,2-dimethyl-1,3-propanediol, 2-methyl-1,3-propanediol, and 1,4-cyclohexanediol).

The poly(trimethylene terephthalate) can contain minor amounts of other comonomers, and such comonomers are usually selected so that they do not have a significant adverse affect on properties. Such other comonomers include 5-sodium-sulfoisophthalate, for example, at a level in the range of about 0.2 to 5 mole %. Very small amounts of trifunctional comonomers, for example trimellitic acid, can be incorporated for viscosity control.

A particular preferred poly(trimethylene terephthalate) is one in which the 1,3-propane diol used to make the polymer comprises (preferably substantially comprises) a 1,3-propane diol prepared by a fermentation process using a renewable biological source. As an illustrative example of a starting material from a renewable source, biochemical routes to 1,3-propanediol (PDO) have been described that utilize feedstocks produced from biological and renewable resources such as corn feed stock. For example, bacterial strains able to convert glycerol into 1,3-propanediol are found in the species Klebsiella, Citrobacter, Clostridium, and Lactobacillus. The technique is disclosed in several publications, including previously incorporated U.S. Pat. No. 5,633,362, U.S. Pat. No. 5,686,276 and U.S. Pat. No. 5,821,092. U.S. Pat. No. 5,821,092 discloses, inter alia, a process for the biological production of 1,3-propanediol from glycerol using recombinant organisms. The process incorporates E. coli bacteria, transformed with a heterologous pdu diol dehydratase gene, having specificity for 1,2-propanediol. The transformed E. coli is grown in the presence of glycerol as a carbon source and 1,3-propanediol is isolated from the growth media. Since both bacteria and yeasts can convert glucose (e.g., corn sugar) or other carbohydrates to glycerol, the processes disclosed in these publications provide a rapid, inexpensive and environmentally responsible source of 1,3-propanediol monomer.

The biologically-derived 1,3-propanediol, such as produced by the processes described and referenced above, contains carbon from the atmospheric carbon dioxide incorporated by plants, which compose the feedstock for the production of the 1,3-propanediol. In this way, the biologically-derived 1,3-propanediol preferred for use in the context of the present invention contains only renewable carbon, and not fossil fuel-based or petroleum-based carbon. The poly(trimethylene terephthalates) based thereon utilizing the biologically-derived 1,3-propanediol, therefore, have less impact on the environment as the 1,3-propanediol used in the compositions does not deplete diminishing fossil fuels and, upon degradation, releases carbon back to the atmosphere for use by plants once again.

Preferably the 1,3-propanediol used as the reactant or as a component of the reactant will have a purity of greater than about 99%, and more preferably greater than about 99.9%, by weight as determined by gas chromatographic analysis. Particularly preferred are the purified 1,3-propanediols as disclosed in U.S. Pat. No. 7,038,092, U.S. 2004-0260125A1, U.S. 2004-0225161A1 and U.S. 2005-0069997A1.

The purified 1,3-propanediol preferably has the following characteristics:

(1) an ultraviolet absorption at 220 nm of less than about 0.200, and at 250 nm of less than about 0.075, and at 275 nm of less than about 0.075; and/or

(2) a composition having L*a*b* “b*” color value of less than about 0.15 (ASTM D6290), and an absorbance at 270 nm of less than about 0.075; and/or

(3) a peroxide composition of less than about 10 ppm; and/or

(4) a concentration of total organic impurities (organic compounds other than 1,3-propanediol) of less than about 400 ppm, more preferably less than about 300 ppm, and still more preferably less than about 150 ppm, as measured by gas chromatography.

The intrinsic viscosity of the poly(trimethylene terephthalate) of the invention is at least about 0.5 dL/g, preferably at least about 0.7 dL/g, more preferably at least about 0.8 dL/g, more preferably at least about 0.9 dL/g, and most preferably at least about 1 dL/g. The intrinsic viscosity of the polyester composition of the invention are preferably up to about 2.5 dL/g, more preferably up to about 2 dL/g, even more preferably up to about 1.5 dL/g, and most preferably up to about 1.2 dL/g.

Poly(trimethylene terephthalate) and preferred manufacturing techniques for making poly(trimethylene terephthalate) are described in U.S. Pat. No. 5,015,789, U.S. Pat. No. 5,276,201, U.S. Pat. No. 5,284,979, U.S. Pat. No. 5,334,778, U.S. Pat. No. 5,364,984, U.S. Pat. No. 5,364,987, U.S. Pat. No. 5,391,263, U.S. Pat. No. 5,434,239, U.S. Pat. No. 5,510,454, U.S. Pat. No. 5,504,122, U.S. Pat. No. 5,532,333, U.S. Pat. No. 5,532,404, U.S. Pat. No. 5,540,868, U.S. Pat. No. 5,633,018, U.S. Pat. No. 5,633,362, U.S. Pat. No. 5,677,415, U.S. Pat. No. 5,686,276, U.S. Pat. No. 5,710,315, U.S. Pat. No. 5,714,262, U.S. Pat. No. 5,730,913, U.S. Pat. No. 5,763,104, U.S. Pat. No. 5,774,074, U.S. Pat. No. 5,786,443, U.S. Pat. No. 5,811,496, U.S. Pat. No. 5,821,092, U.S. Pat. No. 5,830,982, U.S. Pat. No. 5,840,957, U.S. Pat. No. 5,856,423, U.S. Pat. No. 5,962,745, U.S. Pat. No. 5,990,265, U.S. Pat. No. 6,232,511, U.S. Pat. No. 6,235,948, U.S. Pat. No. 6,245,844, U.S. Pat. No. 6,255,442, U.S. Pat. No. 6,277,289, U.S. Pat. No. 6,281,325, U.S. Pat. No. 6,297,408, U.S. Pat. No. 6,312,805, U.S. Pat. No. 6,325,945, U.S. Pat. No. 6,331,264, U.S. Pat. No. 6,335,421, U.S. Pat. No. 6,350,895, U.S. Pat. No. 6,353,062, U.S. Pat. No. 6,437,193, U.S. Pat. No. 6,538,076, U.S. Pat. No. 6,841,505 and U.S. Pat. No. 6,887,953, all of which are incorporated herein by reference.

Poly(trimethylene terephthalate)s useful as the polyester of this invention are commercially available from E. I. du Pont de Nemours and Company, Wilmington, Del., under the trademark SORONA, and from Shell Chemicals, Houston, Tex., under the trademark CORTERRA.

The polymerized alpha-hydroxy acids (“PAHA”) used in the practice of the present invention include polymers of lactic acid (including polymers of its stereo-specific dimer L(−)lactide), glycolic acid (including its dimer glycolide), and 2-hydroxy butyric acid. Also included in the term “polymerized alpha-hydroxy acid” are copolymers of PLA such as the copolymers of PLA and ε-caprolactone (2-oxepanone) and/or γ-caprolactone (5-ethyl-2-oxolanone).

Any grade of PLA can be used for practicing this invention. The preferred poly(lactic acid) (PLA) used in the practice of the present invention is a 100% bio-derived polymer, prepared catalytically from L(−)lactide, preferably having a melting point of 130-200° C. The intrinsic viscosity of the PLA used in the practice of the present invention is preferably at least about 0.7 dL/g, more preferably at least about 0.9 dL/g, and is preferably at up to about 2.0 dL/g, more preferably up to about 1.6 dL/g.

PLA's suitable for practicing this invention are available from Cargill, Inc., Minetonka, Minn., and one preferred grade is PLA Polymer 4040D, and others.

The PTT/PAHA polymer compositions can be prepared by any known technique, including physical blends and melt blends. Preferably the PTT and PAHA are melt blended and compounded. Preferably PTT and PAHA are mixed and heated at a temperature sufficient to form a blend, and upon cooling, the blend is formed into a shaped article, such as pellets. The PTT and PAHA can be formed into a blend in many different ways. For instance, they can be (a) heated and mixed simultaneously, (b) pre-mixed in a separate apparatus before heating, or (c) heated and then mixed. As an example, the polymer blend can be made by transfer line injection. The mixing, heating and forming can be carried out by conventional equipment designed for that purpose such as extruders, Banbury mixers or the like. The temperature should be above the melting points of each component but below the lowest decomposition temperature, and accordingly must be adjusted for any particular composition of PTT/PAHA polymers. Temperature is typically in the range of about 180° C. to about 260° C., preferably at least about 230° C. and more preferably up to about 250° C., depending on the particular PTT and PAHA of the invention.

The polymer compositions can, if desired, contain certain additives, e.g., heat stabilizers, nucleating agents, viscosity boosters, optical brighteners, pigments, and antioxidants.

Depending upon the intended end-use application, the polymer may contain minor amounts of other thermoplastic resins or known additives that are conventionally added to thermoplastic resins, for example, stabilizers such as ultraviolet absorbers, and antistatic agents. Of course, these additives should not be employed in amounts which would adversely affect the benefits achieved by the present invention.

Polyamides such as Nylon 6 or Nylon 6-6 can be added in minor amounts of about 0.5 to about 15 weight %, based upon the weight of the polymer composition, to improve properties (e.g. strength) and processability to the compositions of the invention.

A preferred nucleating agent, preferably 0.005 to 2 wt % of a monosodium salt of a dicarboxylic acid selected from the group consisting of monosodium terephthalate, mono sodium naphthalene dicarboxylate and mono sodium isophthalate, as a nucleating agent, can be added as described in U.S. Pat. No. 6,245,844.

The compositions of the invention may be formed into cast or biaxially oriented films, sheets or other articles. These films typically have size of about 0.1 mil to about 100 mils. The film may be a monolayer film, or a multilayer film formed in a coextrusion with other film layers including polyolefins, ethylene copolymers, ionomers, polyamides, polycarbonates, acrylics, polystyrenes, adhesive tie layers, ethylene vinyl alcohol, polyvinylidene chloride or other synthetic polymers. The monolayer film can also be laminated to other films or substrates.

The polymer compositions can be made into film, including both cast and biaxially oriented films, using conventional equipment. The steps involved are typically: preparing a dry blend of polymer, melt-blending the polymers, extruding the polymers to form pellets (including other shapes such as flakes, etc.), remelting the pellets, extruding the pellets through a die, and can be carried out at temperatures in the range of about 180° C. to about 260° C. The polymer compositions of the invention provide novel changes in physical properties over PTT itself.

The following examples are presented for the purpose of illustrating the invention, and are not intended to be limiting. All parts, percentages, etc., are by weight unless otherwise indicated.

### EXAMPLES

Materials

The PTT used was SORONA bright poly(trimethylene terephthalate) (E. I. du Pont de Nemours and Company, Wilmington, Del.), having an intrinsic viscosity of 1.02 dl/g.

The PLA used was PLA Polymer 4040D poly(lactic acid) from Cargill, Inc., Minetonka, Minn.

Test Method 1. Measurement of Intrinsic Viscosity

The PTT and PAHA intrinsic viscosities (IV) were determined using viscosity measured with a Viscotek Forced Flow Viscometer Y900 (Viscotek Corporation, Houston, Tex.) for the polymer dissolved in 50/50 weight % trifluoroacetic acid/methylene chloride at a 0.4 grams/dL concentration at 19° C. following an automated method based on ASTM D 5225-92. The PTT measured IV values were correlated to IV values measured manually in 60/40 wt % phenol/1,1,2,2-tetrachloroethane following ASTM D 4603-96. See also U.S. Pat. No. 5,840,957.

Test Method 2. Physical Property Measurements

The physical properties of the films were measured using test samples using an Instron Corp. Tensile Tester, Model no.1125 (Instron Corp., Norwood Mass.).

The tensile properties were measured according to ASTM D-638.

### Examples 1-3 and Comparative Example A

Films were prepared by extruding polymers according to the invention and a control polymer of PTT.

PTT was dried in air oven at 120° C. for 16 hours. PLA polymer 4040d was dried at 80° C. for 16 hours.

Polymer blends of the PTT and PLA were prepared in a 28 mm twin-screw extruder at 249° C. Films were extruded through a standard die, quenched by passing through a water chilled roll, cooled to room temperature and wound. Films of various thickness were prepared, and data for 4 mil thick films are provided below in Table 1. Each data point is the mean of 10 individual test samples.

TABLE 1
PTT/PLA Film Properties

| | PLA | | MODULUS | STRESS MAX | STRAIN AT |
|---|---|---|---|---|---|
| EX | (wt %) | | (KSI) | (KSI) | BREAK (%) |
| A | 0 | XD | 265.46 | 5.05 | 2.29 |
| | | MD | 265.73 | 5.67 | 2.55 |
| 1 | 5 | XD | 278.60 | 5.47 | 2.30 |
| | | MD | 273.91 | 5.47 | 2.35 |
| 2 | 10 | XD | 277.93 | 5.38 | 2.27 |
| | | MD | 274.70 | 5.26 | 2.38 |
| 3 | 20 | XD | 288.68 | 5.24 | 2.09 |
| | | MD | 301.90 | 5.63 | 2.17 |
| 4 | 40 | MD | 321.74 | 6.86 | 2.77 |
| 5 | 50 | MD | 348.08 | 7.82 | 2.93 |
| 6 | 60 | MD | 351.42 | 8.01 | 3.00 |

XD = cross-direction.
MD = machine-direction (longitudinal).

The modulus of the samples (in both cross-direction and machine-direction) increased with increased levels of PLA. The stress in the cross-direction is also improved with addition of PLA to PTT.

These changes were particularly unexpected since PLA generally has significantly worse strength properties, such as modulus, than PTT.

The foregoing disclosure of embodiments of the invention has been presented for purposes of illustration and description. It is not intended to be exhaustive or to limit the invention to the precise forms disclosed. Many variations and modifications of the embodiments described herein will be obvious to one of ordinary skill in the art in light of the disclosure.

What is claimed is:

1. A film comprising a polymer composition comprising about 20 to about 98 wt %, by weight of the polymer composition, of poly(trimethylene terephthalate) and about 80 to about 2 wt %, by weight of the polymer composition, of poly(alpha-hydroxy acid).

2. The film of claim 1, wherein the poly(alpha-hydroxy acid) is polylactic acid.

3. The film of claim 2, wherein the polylactic acid is a bio-dervied polymer.

4. The film of claim 1, wherein the poly(trimethylene terephthalate) is made with a 1,3-propane diol prepared by a fermentation process using a renewable biological source.

5. The film of claim 3, wherein the poly(trimethylene terephthalate) is made with a 1,3-propane diol prepared by a fermentation process using a renewable biological source.

6. The film of claim 1, wherein the film is about 0.1 mil to about 100 mils thick.

7. A multilayer film comprising at least one film layer comprising a film comprising a polymer composition comprising about 20 to about 98 wt %, by weight of the polymer composition, of poly(trimethylene terephthalate) and about 80 to about 2 wt %, by weight of the polymer composition, of poly(alpha-hydroxy acid).

8. The multilayer film of claim 7, wherein the poly(alpha-hydroxy acid) is polylactic acid.

9. The multilayer film of claim 8, wherein the polylactic acid is a bio-dervied polymer.

10. The multilayer film of claim 7, wherein the poly(trimethylene terephthalate) is made with a 1,3-propane diol prepared by a fermentation process using a renewable biological source.

11. The multilayer film of claim 9, wherein the poly(trimethylene terephthalate) is made with a 1,3-propane diol prepared by a fermentation process using a renewable biological source.

12. The multilayer film of claim 7, wherein the film is about 0.1 mil to about 100 mils thick.
